(19) United States
(12) Patent Application Publication
(10) Pub. No.: US 2005/0071263 A1
(43) Pub. Date: Mar. 31, 2005

(54) Asymmetrical accounting for a stable value investment product

(76) Inventor: Sebastian Janssen, Pittstown, NJ (US)

Correspondence Address: FULBRIGHT & JAWORSKI, LLP, 666 FIFTH AVE, NEW YORK, NY, 10103-3198, US

(21) Appl. No.: 10/825,991

(22) Filed: Apr. 16, 2004

Related U.S. Application Data
(60) Provisional application No. 60/463,785, filed on Apr. 18, 2003.

(51) Int. Cl. G06F 17/60

(52) U.S. Cl. 705/35

(57) ABSTRACT

A stable value investment product which asymmetrically accounts for an assessment by applying the assessment to market value of the stable value investment product and adjusting the assessment applied to stably value of the stable value investment product by a ratio of the stable value to the market value, thereby minimizing put exposure to a wrap provider. Also, a system for administering such stable value investment products.

### RELATED APPLICATION

The present application claims a priority to U.S. Provisional Patent Application Ser. No. 60/463,785, which is incorporated herein in its entirety.

### BACKGROUND OF THE INVENTION

The present invention relates to a method and system for accounting a stable value fund, more particularly to an asymmetrical accounting of stable value fund.

Traditional universal life (UL) utilizes side fund accounting. For instance, in the non-stable UL products, there is a fund associated with each insured. Typically, certain charges are levied or assessed against the insured's fund or account and investment income is credited to the insured's fund or account. These charges or assessments can be broadly categorized as 1) policy charges; 2) release of cash value on death; 3) asset based and investment fees; 4) other insurance related charges. Policy charges can include flat dollar charge per life, flat per thousand charges, and COI (Cost of Insurance) charges. COIs are generally developed based on two elements: (a) the rate basis which varies by the appropriate risk category (sex, smoker, underwriting class etc); and (b) the NAR (net amount of risk). The NAR can be crudely defined to be the Face Amount (or amount to be paid on death) less the account value. Symbolically, the NAR can be expressed as NAR=FA−AV.

Upon death, the insurance company typically pays a stipulated death benefit and the insurance contract terminates. The account value is therefore zero once the claim has been paid. In the insurance industry, the fact that the account value goes to zero upon death is often referred to as the “account value being released upon death”. Asset based fees and/or investment fees are generally assessed in a variable insurance contract and M&E (mortality and expense) charges are typically assessed against the account value of the insured's fund.

The purpose of a stable value fund is to stabilize the return of the market value fund, or stated somewhat differently, to mitigate the investment volatility of the market value fund. This achieved by the carrier entering into a contractual arrangement with one or more wrap providers who provided a payment to the carrier of the difference between the stable value and the market value when the policyholder surrenders the insurance contract. The policyholder has to meet certain criteria specified requirements in order to obtain the stable value. The stable value can be determined by a standard formula used in the insurance industry. The stable value rate reflects anticipated future earnings of the market value fund and amortizing the difference between stable value and market value prospectively.

Traditional stable value product or fund tracks information at two levels: the stable value and the market value. The stable value is tracked at the individual insured level. The market value is tracked at the contract level and is not explicitly assigned to the individual insured. In certain instances, the market value of the traditional stable value fund cannot be explicitly assigned to the individual insured in consistent manner.

Accordingly, the dual accounting is generally required for a stable value product to track both stable and market values. Various product related charges, such as policy charges, release on death, M&E charges, and asset based charges, etc., are determined and assessed against the market and stable values of the stable value investment product or fund. Policy charges and release on death charges determined at the individual insured level are assessed at that level. These charges are then aggregated and charged at the contract level.

By way of example, suppose the insured group consists of 10 lives. A stable value of $100 is associated with each life. The aggregate market value is $900. This information is summarized in the following Table 1.

TABLE 1

| | Individual | Aggregate |
|---|---|---|
| | Insured | Contract |
| Stable Value | $100 | $1,000 |
| Market Value | N/A | $900 |
| Ratio | | 1.1111 |

By way of example, assume the COI has been determined to be $20 per life. The COI is then charged against the stable value of each life and, in aggregate, $200 is collected against the contract.

The effect on the values in the traditional stable value scenario can be summarized in the following Table 2.

TABLE 2

| | Individual | Aggregate |
|---|---|---|
| | Insured | Contract |
| Stable Value | $100 − $20 = $80 | $1,000 − $200 = $800 |
| Market Value | N/A | $900 − $200 = $700 |
| Ratio | | 1.1428 |

This is an example what is referred to herein as “constant dollar” accounting. That is, the same dollar amount is effectively charged against both the stable value and market value. This type of accounting can adversely impact the risk position of the stable value or wrap provider.

The wrap provider is at risk for the difference between the stable value and the market value. The put exposure is one risk metric of the wrap providers and can be defined as the ratio of the contract's stable value to market value. A ratio of 1 is neutral. A number greater than 1 represents adverse exposure. The greater the ratio the greater the risk exposure.

In situation where the stable value is greater than the market value, the “constant dollar” accounting method of reflecting charges has the effect of increasing the risk exposure to the wrap provider. As shown in Tables 1 and 2, after the charges are assessed or levied against the stable value and market value, the wrap provider's risk ratio increased to 1.14 from 1.11 (pre-assessment).

If the obverse were true, i.e., the stable value was less than market value, then the constant dollar accounting would ameliorate the risk position of the wrap provider. But the wrap provider imposes restrictions in the wrap structure to mitigate the adverse risk. To liberalize the wrap provisions, the wrap structure has to be mortality neutral.

As another example, the impact of a death claim would effect the risk exposure to the wrap provider. The payment of the death claim would result in the stable value of the decedent being released (to the carrier).

Utilizing the example discussed herein and delineated in Tables 1 and 2, if one death claim results in $100 being released to the carrier, then the risk ratio would increase as shown in the Table 3.

TABLE 3

| | Individual | Aggregate |
|---|---|---|
| | Insured | Contract |
| Stable Value | $100 − $100 = $0 | $1,000 − $100 = $900 |
| Market Value | N/A | $900 − $100 = $800 |
| Ratio | | 1.125 |

Therefore, it is desirable to have a system and method which accounts for risks and various insurance product related charges levied against the stable value investment product in a manner which does not adversely affect the stable value or wrap provider's risk ratio.

### OBJECT AND SUMMARY OF THE INVENTION

Therefore, it is an object of the present invention to provide a stable value product, and an accounting method and system for administering stable value products, which overcomes the above-noted shortcomings of the traditional stable value product.

It is another object of the present invention to provide a system and method for asymmetrical accounting of risks and expenses for stable value fund, thereby minimizing the risk exposure of the wrap provider and/or stable value provider.

It is further object of the present invention to provide a stable value fund or product, which accounts or treats the risks and expenses (such as mortality risk, COIs, etc.) asymmetrically to minimize the risk exposure of the wrap provider and/or stable value provider.

The asymmetrical accounting or option adjusted accounting method and system in accordance with an embodiment of the present invention advantageously enables the wrap provider and/or stable value provider to use dual accounting at the individual insured level and to account for death benefits and COIs, which minimizes the risk exposure of the wrap provider.

The asymmetrical accounting method and system for stable value fund, and the stable value fund employing such asymmetrical accounting eliminate or minimize the mortality risk to the stable value and/or wrap provider, and therefore allows the stable value providers to offer stable value coverage in a broader range of circumstances. In particular, the stable value provider can provide a stable value product or protection to smaller groups than they would have otherwise using a traditional stable value product. Additionally, the cost of continuing stable value coverage beyond certain age thresholds is less expensive using the stable value fund of the present invention than the traditional stable value fund. Typically, under the traditional stable value fund, the wrap provider would either terminate the stable value coverage or require an investment change to a high quality short duration portfolio once the average age of the insured population exceeds some threshold (typically, 70 or 75 years of age). The present invention advantageously eliminates this requirement and the stable value providers can continue to provide stable value coverage regardless of the average age of the insured population without increasing their risk exposure.

The asymmetrical accounting of present invention enables the carrier to adhere to a more conservative compliance with Section 7702 of the Internal Revenue Code. Section 7702 requires that the minimum death benefit factors be applied to the greater of market value and stable value of the insured. However, the current dual accounting of tracking the stable value at the insured level and tracking the market value at the contract level only permits the minimum death benefit factors to be based on the stable value. Since, the asymmetrical accounting of the present invention tracks both market value and stable value at the insured level, the present invention permits the carrier to base the minimum death benefit factors on either the stable value and market value.

The asymmetrical accounting of the present invention enables the stable value provider to recognize death benefits in a timely or stable manner. That is, the stable value product of the present invention provides stabilized death benefits.

In accordance with an embodiment of the present invention, a stable value investment product which asymmetrically accounts for an assessment by applying the assessment to market value of the stable value investment product and adjusting the assessment applied to stable value of the stable value investment product by a ratio of the stable value to the market value, the ratio being based on the stable value and the market value prior to applying the assessment or the adjusted assessment, thereby minimizing put exposure to a wrap provider.

In accordance with an embodiment of the present invention, a computer-based method for asymmetrically accounting an assessment in a stable value investment product, comprising the steps of: adjusting an assessment by a ratio of stable value of the stable value investment product to market value of the stable value investment product to provide an adjusted assessment; applying the assessment to the market value; and applying the adjusted assessment to the stable value, thereby minimizing the put exposure to a wrap provider.

In accordance with an embodiment of the present invention, a system for administering a stable value investment product comprises a module for receiving an assessment, a stable value of said stable value investment product and a market value of said stable value investment product. A processing device adjusts the assessment by a ratio of the stable value to the market value to provide an adjusted assessment. The processing device deducts the assessment from the market value to provide a new market value, but deducts the adjusted assessment from the stable value to provide a new stable value, thereby minimizing the put exposure to a wrap provider. A storage device then stores the new market value and the new stable value.

In accordance with an embodiment of the present invention, a computer readable medium comprises code for asymmetrically accounting an assessment in a stable value investment product. The code comprises instructions for: adjusting an assessment by a ratio of stable value of said stable value investment product to market value of said stable value investment product to provide an adjusted assessment; applying said assessment to said market value; and applying said adjusted assessment to said stable value, thereby minimizing the put exposure to a wrap provider.

Various other objects, advantages and features of this invention will become readily apparent from the ensuing detailed description and the appended claim.

### BRIEF DESCRIPTION OF THE DRAWINGS

The following detailed description, given by way of example, and not intended to limit the present invention solely thereto, will best be understood in conjunction with the accompanying drawings and Appendix in which:

FIG. 1 is a block diagram of a system for administering a stable value investment product in accordance with an embodiment of the present invention; and

FIG. 2 is a flow chart describing the process by which an embodiment of the present invention asymmetrically accounts for an assessment in a stable value investment product.

### DETAILED EMBODIMENT OF THE PRESENT INVENTION

In accordance with an embodiment of present invention, the asymmetrical accounting or option adjusted accounting employs dual accounting to maintain stable value and market value at the individual insured level. In contrast to traditional stable value accounting, which employs a “constant dollar” accounting, the asymmetrical accounting of the present invention adjusts the risks, investment and/or insurance related charges or expenses (collectively referred to herein as the “assessments”) so that the relative level of put exposure remains unchanged following the assessment of such charges.

By way of example, and utilizing the example of the “constant dollar” accounting of the traditional stable value fund as described herein, 10 identical insured are assumed again, each insured having a stable value of $100. Additionally, each insured has an associated market value of $90. This information is summarized in the following Table 4. Table 4.

TABLE 4

| | Individual Insured | Aggregate Contract |
|---|---|---|
| Stable Value | $100 | $1,000 |
| Market Value | $90 | $900 |
| Ratio | 1.1111 | 1.1111 |

Again, assume the COI has been determined to be $20 per life. In the asymmetrical accounting of the present invention, the COIs are determined based on the market value, but the charge against the stable value is adjusted for the put exposure. In accordance with an embodiment of the present invention, the put exposure is measured using the ratio of stable value to market value (before the applying the charges, i.e., COI). In this particular case, the COI is adjusted by a factor of 1.1111 (or $100/$90) resulting in put adjusted COI to the stable value of $22.22. The effect on the individual insured and the aggregate contract is summarized in Table 5.

TABLE 5

| | Individual Insured | Aggregate Contract |
|---|---|---|
| Stable Value | $100 − $22.22 = $77.78 | $1,000 − $222.22 = $777.78 |
| Market Value | $90 − $20.00 = $70.00 | $900 − $200.00 = $700.00 |
| Ratio | 1.1111 | 1.1111 |

That is the risk exposure to the wrap provider and/or stable value provider now is unaffected by the payment of the COI.

In accordance with an embodiment of the present invention, the risk exposure to the wrap provider and/or stable value provider can be similarly neutralized on a death claim. The payment of the death claim results in the market value of the decedent being released (to the carrier) and the stable value charge is adjusted for the put exposure. The put exposure is measured, again, by the ratio of stable value to market value (before the effects of the claim). Again, for this example, the release of $90 is adjusted by the risk exposure factor of 1.1111 (or $100/$90) resulting in a charge of $100 to the stable value. The results are summarized in Table 6.

TABLE 6

| | Individual | Aggregate |
|---|---|---|
| | Insured | Contract |
| Stable Value | $100 − $100 = $0 | $1,000 − $100 = $900 |
| Market Value | $90 − $90 = $0. | $900 − $90 = $810 |
| Ratio | n.a. | 1.1111 |

That is the risk exposure to the wrap provider and/or stable provider is unaffected by the payment of the “release of account value” to the carrier.

Therefore, both COIs and release on death claim has no effect on the put exposure to wrap provider and/or stable value provider of asymmetrically treated stable value fund of the present invention. That is, the put exposure to the wrap provider and/or stable provider of asymmetrically treated stable value fund of the present invention has not changed due to mortality. The wrap structure of asymmetrically treated stable value fund of the present invention is mortality neutral, i.e., mortality risk has been eliminated from the stable value fund.

Table 7 contrasts the treatment of various mortality elements between the traditional stable value approach and the asymmetrical or option adjusted approach of the present invention.

TABLE 7

| Characteristic | Traditional | Option Adjusted |
|---|---|---|
| Insured's Account | Stable Value (SV) | SV and MV (market value) |
| Value | | |
| COI | Based on NAR where | Based on NAR where |
| | NAR = FA − SV | NAR = FA − MV |
| Minimum Death | Based on SV | Based on the greater |
| Benefit | | of SV and MV |
| Determination | | |
| Payment to | SV | MV |
| Carrier | | |

It is appreciated that the risk exposure to the wrap provider will be impacted whenever the “constant dollar” methodology to charges is employed. This is true whether the charge is related to mortality or not. To eliminate the risk to wrap provider, the asymmetrical or option adjusted accounting can be applied to any charges being levied within an insurance contract, such as policy charges or asset based charges described herein.

In accordance with an embodiment of the present invention, option adjusted accounting is an example of asymmetrical accounting. Asymmetrical accounting occurs whenever the charge or credit levied against the stable value is different in magnitude than the corresponding charge or credit levied against the market value.

The usefulness of the present concept embodiment in the present invention can be illustrated by way of example. Stable value insurance product purchasers are generally adverse to volatility in earnings from all sources not just interest rate changes. The payment of a death claim can have the effect of increasing earnings to the policyholder.

This can be demonstrated with an example. Suppose the insurance contract has a pooled mortality arrangement with 10 insureds each with a face amount equal to $1,000. The stable value and market value associated with each insured is $100 and $90, respectively. Upon the death of one insured, the policyholder will experience gain of $900—the difference between the claim and the value held on the policyholder's balance sheet. This information is summarized in Table 8.

TABLE 8

| | Decedent |
|---|---|
| Face | $1,000 |
| Recorded on Books of Policyholder (Stable Value) | $100 |
| Net Impact on earnings | $900 |

This result in a one-year gain (as distinct from gain over the life of the contract) of approximately 90%.

The increase to earnings as a result of the payment of the death benefit is offset by the cost or payments made for obtaining the coverage, i.e., the payment of COIs. If the group of insureds is sufficiently large then the COIs collected across all insureds by the policyholder will roughly approximate the death benefit paid mitigating the volatility. However, if the group of insureds is small, then the COIs collected will not necessarily offset the death benefit payments, thereby increasing the volatility of death benefit claims.

For example, if the rate of death benefit claims is 1 per 1,000 than a group of 10,000 lives or insureds will have expected death benefit claims of 10 per year. A group of 100 lives or insureds will be expected to experience only 1 claim every 10 years.

The volatility of claims can be significantly reduced for smaller groups if the death proceeds are recognized over an extended period of time. This can be accomplished, for example, by having the NAR of the claim deposited back into the insurance contract. The deposit would increase the market value of the remaining insureds but would not immediately increase their stable value. The increase in stable value would occur over time. In accordance with an embodiment of the present invention, the increase could be reflected as a natural byproduct of the rate reset formula.

Continuing with the example, a group of 10 insured (each with the same market value and stable value), the asymmetrical or option adjusted accounting of the present invention would leave the credited rate reset uneffected by the payment of the claim. This is summarized in Table 9.

TABLE 9

| Values | Individual | Group | Following Death |
|---|---|---|---|
| Stable Value | 100 | 1000 | 900 |
| Market Value | 90 | 900 | 810 |
| Rate Reset | | 3.79% | 3.79% |

Although, the calculations in Table 9 has been made with the following rate reset formula, it is appreciated that any known rate reset formula can be used:
(1+Y)*(MV/SV)**(1/D)=Rate Reset, where: Y=6% and D=5.

However, as shown in Table 10, when the NAR is deposited back into the contract under the asymmetrical accounting method of the present invention, the effect is to increase the rate reset prospectively, i.e., the impact of the death is recognized into earnings over the duration of the portfolio.

TABLE 10

| | | | Post Death |
|---|---|---|---|
| Values | Group | Following Death | Individual |
| Stable Value | 1000 | 900 | 100 |
| Market Value | 900 | 810 + NAR (=900) | 190 (90 + 900/9) |
| Rate Reset | 3.79% | 20.52% | |

Again the advantage of the depositing of death claims in this fashion is that the volatility in earnings of death benefits is reduced significantly. That is, the present invention enables the death benefits to be recognized in a stable or timely manner to the policyholder.

The stabilizing impact of the asymmetrical accounting method of the present invention can be illustrated by looking at some key performance measures which are delineated in Table 11:

TABLE 11

| Policyholder | | Stabilized |
|---|---|---|
| Values | Conventional | Death Benefits |
| Stable Value (pre-death) | $1,000 | $1,000 |
| Profit & Loss (P&L) upon death | $900 | — |
| Rate Reset post death | 3.72% | 20.52% |

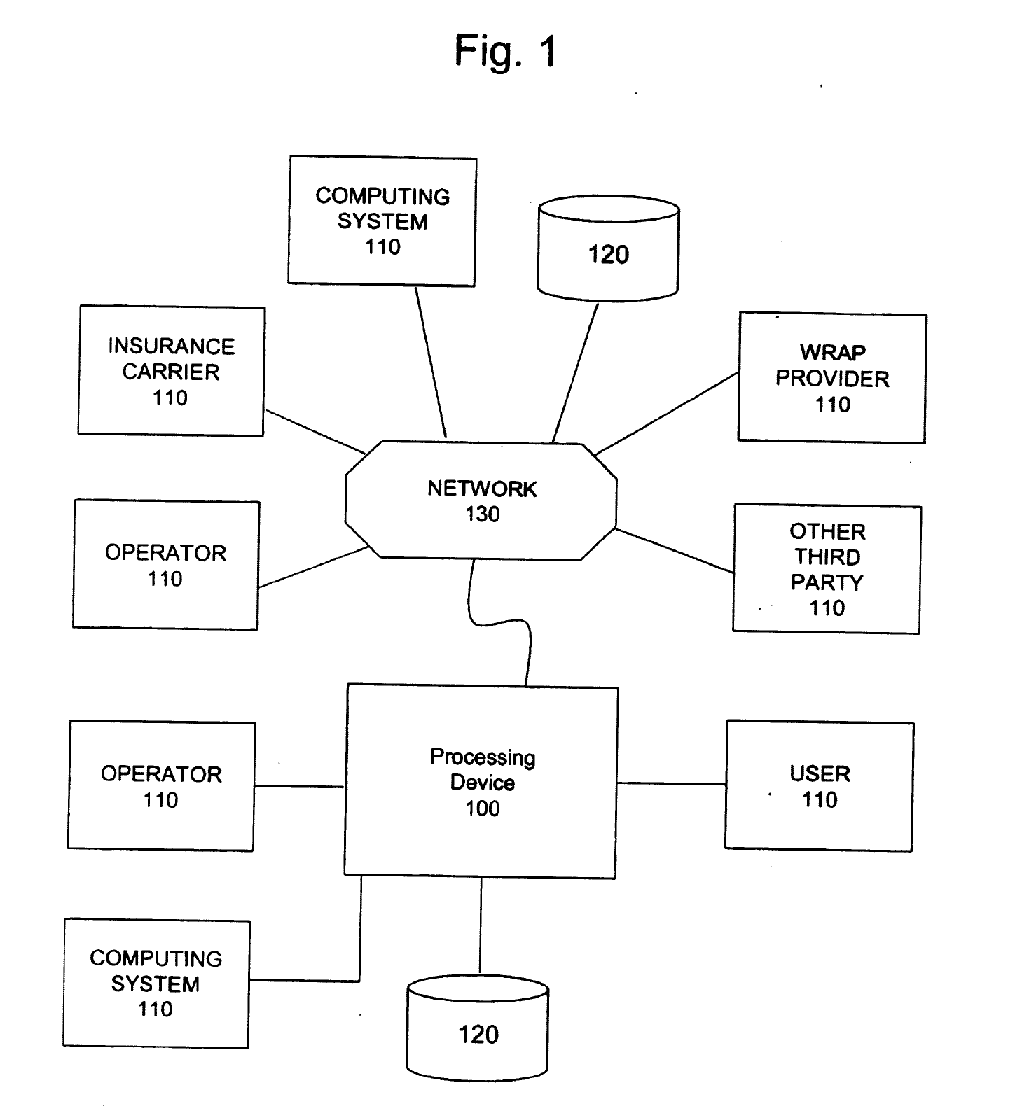

Turning now to FIG. 1, in accordance with an embodiment of the present invention, a processor, processing device, computer, server or the like (collectively referred to herein as the “processing device” 100) administers the asymmetrically treated stable value fund of the present invention. The processing device 100 receives stable value and market value of the stable value fund from a user, operator, wrap provider, insurance carrier, other third-party or a database 120 (collectively referred to herein as the “data source” 110). It is appreciated that these various data sources 110 can be connected to the processing device over a network 130. The processing device 100 also receives from one of the data source 110 one or more assessment, such as COIs, mortality risk, asset based fees, investment fees, etc., to be applied to the stable value fund. Upon receipt of these information, the processing device 100 determines or calculates the option adjusted assessment based on a ratio of stable value to market value. The processing device 100 asymmetrically applies the assessment by applying the assessment to the market value and option adjusted assessment to the stable value, thereby generating a new market value and new stable value. This advantageously minimizes the put exposure to the stable value provider and/or wrap provider. Preferably, a storage device 120 stores the new market value and new stable value.

In accordance with another embodiment of the present invention, a computer readable medium comprises a code for asymmetrically or option adjusted accounting for assessment in a stable value investment product. The code comprises instructions for adjusting the adjustment by a ratio of stable value to market value to provide an adjusted assessment, and asymmetrically accounting for the assessment by applying the assessment to the market value but applying the adjusted assessment to the stable value. This advantageously minimizes the put exposure to the stable value provider and/or wrap provider.

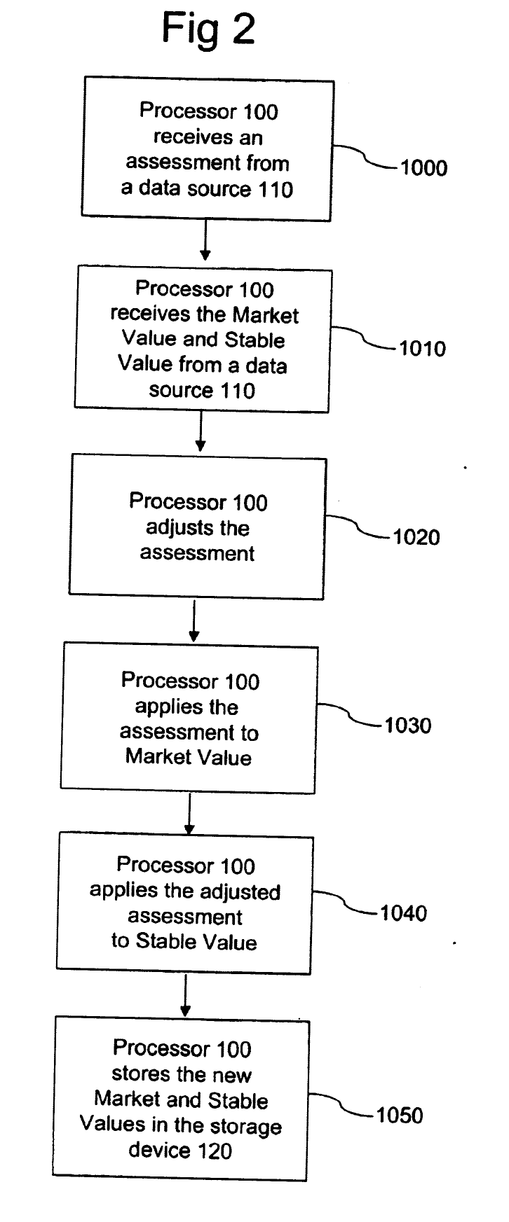

Turning now to FIG. 2, there is illustrated a flowchart describing the process by which an embodiment of the present invention asymmetrically accounts for an assessment in a stable value investment product. The processor or processing device 100 receives from a data source 110 (i.e., an insurance carrier, a wrap provider, a third party, an operator, another computing system, a database, or the like) an assessment at step 1000, and the stable value and market value of the stable investment fund at step 1010. The processing device 100 adjusts the assessment by a ratio of stable value to market value to provide an adjusted assessment at step 1030. The processing device 100 applies the assessment to the market value to generate a new market value at step 1030 and applies the adjusted assessment to the stable value to generate a new stable value at step 1040. The processor 100 stores the new market value and the new stable value in the storage device 120 at step 1050. This process advantageously minimizes the put exposure to the wrap provider.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the spirit of the invention, and the exclusive use of all modifications, which come within the scope of the appended claim, is reserved.

1. A stable value investment product which asymmetrically accounts for an assessment by applying said assessment to market value of said stable value investment product and adjusting said assessment applied to stable value of said stable value investment product by a ratio of said stable value to said market value, said ratio being based on said stable value and said market value prior to applying said assessment or said adjusted assessment, thereby minimizing put exposure to a wrap provider.

2. The stable value investment product of claim 1, wherein said assessment is at least one of the following: policy charges, cost of insurance charges, mortality risk, death benefit payment, mortality and expense (M&E) charges, asset based fees and investment fees.

3. The stable value investment product of claim 1, wherein said stable value and said market value are maintained at an individual insured level which allows for asymmetrical accounting at the individual insured level.

4. The stable value investment product of claim 1, wherein said stable investment product comprises a pooled mortality arrangement with a plurality of insureds and asymmetrically accounts a death benefit claim such that proceeds from said death benefit claim are recognized over an extended period of time.

5. The stable value investment product of claim 4, wherein said proceeds represent a net amount of risk (NAR) of said death benefit claim.

6. The stable value investment product of claim 4, wherein said proceeds from said death benefit claim are deposited into said stable value investment product such that said market value of remaining insureds increases by said proceeds, but said stable value of said remaining insureds increases over time, thereby effectively increasing reset rate prospectively.

7. A computer-based method for asymmetrically accounting an assessment in a stable value investment product, comprising the steps of:
adjusting an assessment by a ratio of stable value of said stable value investment product to market value of said stable value investment product to provide an adjusted assessment;
applying said assessment to said market value; and
applying said adjusted assessment to said stable value,
thereby minimizing the put exposure to a wrap provider.

8. The method of claim 7, further comprising the step of maintaining said market value and said stable value at an individual insured level which allows for asymmetrical accounting at the individual insured level.

9. The method of claim 7, wherein said assessment is at least one of the following: policy charges, cost of insurance charges, mortality risk, death benefit payment, mortality and expense (M&E) charges, asset based fees and investment fees.

10. The method of claim 7, wherein said stable investment product comprises a pooled mortality arrangement with a plurality of insureds; and further comprising the step of asymmetrically accounting a death benefit claim such that proceeds from said death benefit claim are recognized over an extended period of time.

11. The method of claim 10, further comprising the step of determining said proceeds by calculating a net amount of risk (NAR) of said death benefit claim.

12. The method of claim 10, further comprising the step of depositing said proceeds from said death benefit claim into said stable value investment product such that said market value of remaining insureds increases by said proceeds, but said stable value of said remaining insureds increases over time, thereby effectively increasing reset rate prospectively.

13. A system for administering a stable value investment product, comprising:
a module for receiving an assessment, a stable value of said stable value investment product and a market value of said stable value investment product;
a processing device for adjusting said assessment by a ratio of said stable value to said market value to provide an adjusted assessment, deducting said assessment from said market value to provide a new market value, and deducting said adjusted assessment from said stable value to provide a new stable value, thereby minimizing the put exposure to a wrap provider; and
a storage device for storing said new market value and said new stable value.

14. The administering system of claim 13, wherein said assessment is at least one of the following: policy charges, cost of insurance charges, mortality risk, death benefit payment, mortality and expense (M&E) charges, asset based fees and investment fees.

15. The administering system of claim 13, wherein said stable value and said market value are maintained at an individual insured level which allows for asymmetrical accounting at the individual insured level.

16. The administering system of claim 13, wherein said stable investment product comprises a pooled mortality arrangement with a plurality of insureds; and wherein said processing device is operable to asymmetrically account a death benefit claim such that proceeds from said death benefit claim are recognized over an extended period of time.

17. The administering system of claim 16, wherein said processing device is operable to determine said proceeds by calculating a net amount of risk (NAR) of said death benefit claim.

18. The administering system of claim 16, wherein said processing device is operable to deposit said proceeds from said death benefit claim into said stable value investment product such that said market value of remaining insureds increases by said proceeds, but said stable value of said remaining insureds increases over time, thereby effectively increasing reset rate prospectively.

19. A computer readable medium comprising code for asymmetrically accounting an assessment in a stable value investment product, said code comprising instructions for:
adjusting an assessment by a ratio of stable value of said stable value investment product to market value of said stable value investment product to provide an adjusted assessment;
applying said assessment to said market value; and
applying said adjusted assessment to said stable value, thereby minimizing the put exposure to a wrap provider.

20. The computer readable medium of claim 19, wherein said stable investment product comprises a pooled mortality arrangement with a plurality of insureds; and wherein said code further comprises instructions for asymmetrically accounting a death benefit claim such that proceeds from said death benefit claim are recognized over an extended period of time.

21. The computer readable medium of claim 19, wherein said code further comprises instructions for determining said proceeds by calculating a net amount of risk (NAR) of said death benefit claim.

22. The computer readable medium of claim 19, wherein said code further comprises instructions for depositing said proceeds from said death benefit claim into said stable value investment product such that said market value of remaining insureds increases by said proceeds, but said stable value of said remaining insureds increases over time, thereby effectively increasing reset rate prospectively.
